(19) United States
(12) Patent Application Publication
(10) Pub. No.: US 2009/0095167 A1
(43) Pub. Date: Apr. 16, 2009

(54) Bar-B-Que cooking device

(76) Inventor: Keven Groves, Kiowa, CO (US)

Correspondence Address: Keven Groves, PO Box 412, Kiowa, CO, 80117, US

(21) Appl. No.: 12/283,558

(22) Filed: Sep. 13, 2008

Related U.S. Application Data
(60) Provisional application No. 60/979,370, filed on Oct. 11, 2007.

(51) Int. Cl. A47J 37/04

(52) U.S. Cl. 99/421 H

(57) ABSTRACT

A bar-b-que cooking device is described. A cylindrical basket is suspended in proximity to a heating device to form the main body of the bar-b-que cooking device. The basket is connected to a motor which slowly rotates the basket. A smoke box is attached to the main body and allows a user to add wood chips or other smoke-producing materials. Frozen French fries or other foodstuffs are added to the basket and the device is activated, causing the basket to slowly spin around its horizontal axis. Heat from the heating device cooks the foodstuffs while the smoke box adds the smoky, outdoor-cooking flavors. The spinning action of the basket continuously repositions the foodstuffs during cooking so that they cook evenly.

### CROSS-REFERENCE TO RELATED APPLICATIONS

This application claims benefit of U.S. Provisional Application No. 60/979,370, entitled “Bar-b-que French Fryer” and filed on Oct. 11, 2007, which is specifically incorporated herein by reference for all that it discloses and teaches.

### TECHNICAL FIELD

The invention relates generally to cooking and cooking devices, and more particularly to a bar-b-que cooking device that can be utilized to prepare French fries and other foods.

### BACKGROUND

Outdoor cooking of meat and other foods continues to be a favorite pastime of many people. From skewering hotdogs over open fires to grilling porterhouse steaks in multi-thousand-dollar, gourmet gas grills, the method of choice can be quite varied. However, one common limitation is that small, individual food items often end up in the fire or are otherwise wasted as they fall off skewers or slip between the bars on a grill. Thus, some foodstuffs such as French fries, sliced vegetables, nuts, etc. are relegated to being cooked or prepared indoors. And since indoor methods can not easily replicate the smoky, char-broiled flavor imparted by outdoor cooking, such foodstuffs can not easily be imbued with the flavors of outdoor cooking. Another common problem is that current devices often have hotspots that can overcook portions of foodstuffs, especially when the foodstuffs are relatively small (e.g., French fries).

There is therefore a need for a device that can quickly, easily and evenly cook French fries, sliced vegetables, nuts, and other foodstuffs while imbuing them with the flavors of outdoor cooking.

### SUMMARY

Embodiments of the present invention described and claimed herein address the foregoing problems by application of a device that allows French fries, sliced vegetables, nuts, and other foodstuffs to be cooked or prepared out-of-doors using a grilling and/or smoking action. Various embodiments are described and recited herein. Although materials and methods similar or equivalent to those described herein can be used in the practice of the invention, suitable materials and methods are described below. Furthermore, the materials, methods, and examples are illustrative and not intended to be limiting.

In one embodiment, a cylindrical basket is suspended above a heating element to form the main body of a bar-b-que cooking device. The basket is connected to a motor which slowly spins the basket. A smoke box is attached to the main body and allows a user to add wood chips or other smoke-producing materials. French fries or other foodstuffs are added to the basket and the device is activated, causing the basket to slowly spin around its horizontal axis. Heat from the heating device cooks the foodstuffs while the smoke box adds the smoky, outdoor-cooking flavors.

The present invention provides many benefits over the prior art. Common outdoor cooking devices often have hotspots which cause some pieces or portions of the foodstuffs to be overcooked, while other pieces or portions are undercooked. The rotating cylindrical basket continuously turns and moves the foodstuffs so that they cook evenly. Furthermore, the basket has a plurality of holes which allow the smoke and heat to be applied evenly to the foodstuffs. The relatively small size of these holes keeps the foodstuffs from falling out of the basket and onto the heating device—unlike other outdoor cooking devices which have the ever-present risk of foodstuffs falling between the grilling bars or off the skewers and into the fire.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of a bar-b-que cooking device.

FIG. 2 illustrates a left side view of an exemplary embodiment of a bar-b-que cooking device.

FIG. 3 illustrates a right side view of an exemplary embodiment of a bar-b-que cooking device.

### DETAILED DESCRIPTION

A new and novel bar-b-que cooking device is described. In one embodiment, a cylindrical basket is suspended above a heating element to form the main body of a bar-b-que cooking device. The basket is connected to a motor which slowly spins the basket. A smoke box is attached to the main body and allows a user to add wood chips or other smoke-producing materials. French fries or other foodstuffs are added to the basket and the device is activated, causing the basket to slowly spin around its horizontal axis. Heat from the heating device cooks the foodstuffs while the smoke box adds the smoky, outdoor-cooking flavors.

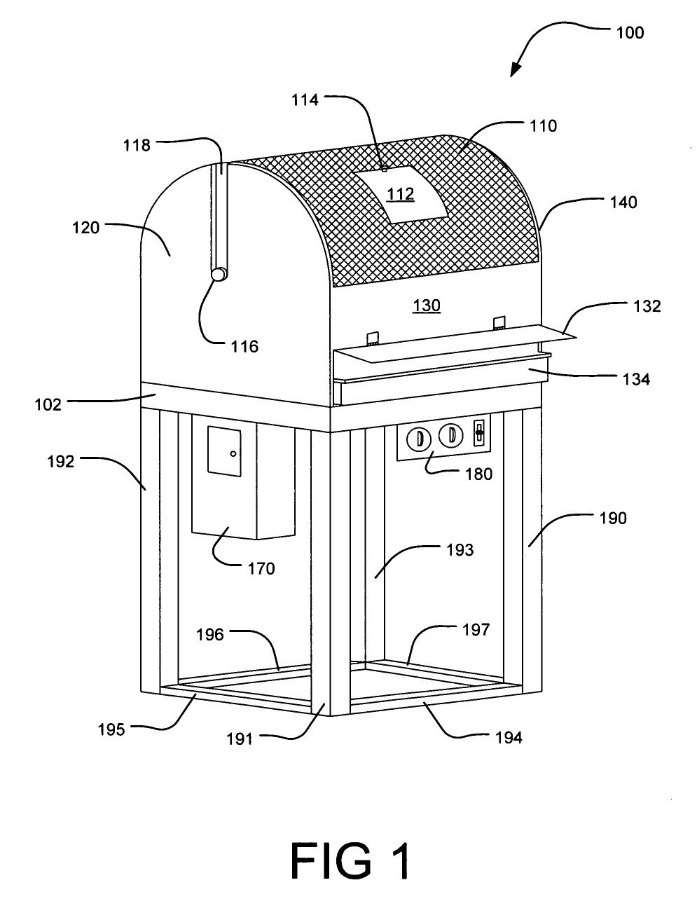

FIG. 1 illustrates a perspective view of an exemplary embodiment of a bar-b-que cooking device 100. The main body of the cooking device 100 is formed by the front wall 130, the left side wall 140, the right side wall 120, and the rear wall (not shown in FIG. 1). The basket 110 is placed in proximity to a heating device 102. As shown in the embodiment in FIG. 1, the basket 110 is suspended between the right side wall 120 and the left side wall 140. The basket retainer bolt handle 116 is placed in the access slot 118 in the right side wall 120. An unlocked basket 110 can be lifted out of the cooking device 100 by grasping the retainer bolt handle 116 and lifting. The basket 110 illustrated in FIG. 1 is generally cylindrical in shape. In other embodiments, the basket 110 can be sized and shaped differently.

The interior of the basket 110 acts as the cooking chamber. The basket 110 can be constructed out of wire mesh or any other suitable material that allows smoke and heat to enter the cooking chamber, while retaining foodstuffs within the chamber. The basket 110 is connected to a motor 260 which slowly rotates the basket 110. The motor is preferably electric, but can be any device which can be adapted to provide motion to the basket 110. Intermediary devices such as pulleys, gears, transmissions, etc. can be placed between the basket 110 and the motor 260 without departing from the scope of the invention.

In the embodiment shown in FIG. 1, the cooking device 100 has a smoke box 170. The smoke box 170 allows a cook to add smoke-flavor to the foodstuffs by feeding smoke into the basket 110. The cook activates the smoke box 170 by adding wood chips or other smoke-producing materials and turning on a secondary heating device placed within or near the smoke box 170. Alternatively, the smoke box 170 could be positioned so as to utilize heat from the primary heating device 102. The secondary heating device can be an electric element, a propane burner, or any other heat-producing device.

Frozen French fries or other foodstuffs can be added to the basket 110 through the door 112. The door latch 114 is used to open the door 112. In order to begin the cooking process, the cooking device 100 must be activated. This is accomplished by working the controls 180. The controls 180 can include switches, dials, or any other controls known in the art for operating smokers or bar-b-que devices. In the embodiment shown in FIG. 1, there are three controls: a push-dial to ignite and control the primary heat device 102, a push-dial to ignite and control the secondary heat device, and a slide-switch to turn on the motor 260 and control the rate of movement of the basket 110. Once the device 100 is activated, the basket 110 begins to spin around its horizontal axis. Heat from the heating device 102 cooks the foodstuffs while the smoke box 170 adds the smoky, outdoor-cooking flavors. The spinning action of the basket 110 continuously repositions the foodstuffs during cooking so that they cook evenly.

The main body of the device 100 illustrated in FIG. 1 is supported by legs 190, 191, 192 and 193. Other embodiments having full side walls, a support cabinet, or any other support structure in place of legs are contemplated. The legs 190, 191, 192 and 193 are shown in FIG. 1 as having cross-supports 194, 195, 196 and 197. Other embodiments having alternative support structures are contemplated.

Once cooking is complete, the serving slot port 132 is opened and the drawer 134 is slid into the front wall 130. The basket 110 can then be opened. Additional movement of the basket 110 causes the foodstuffs within to empty into the serving drawer 134. The efficiency of the emptying procedure can be increased by lifting the bolt handle 116 to angle the basket 110. Furthermore, the door 112 is shown in FIG. 1 as being in the center of the basket 110. Instead, the door 112 can be positioned to the basket's 110 left side, closer to left side wall 140. Thus, when the basket 110 is raised up at an angle, the foodstuffs slide towards the open door 112.

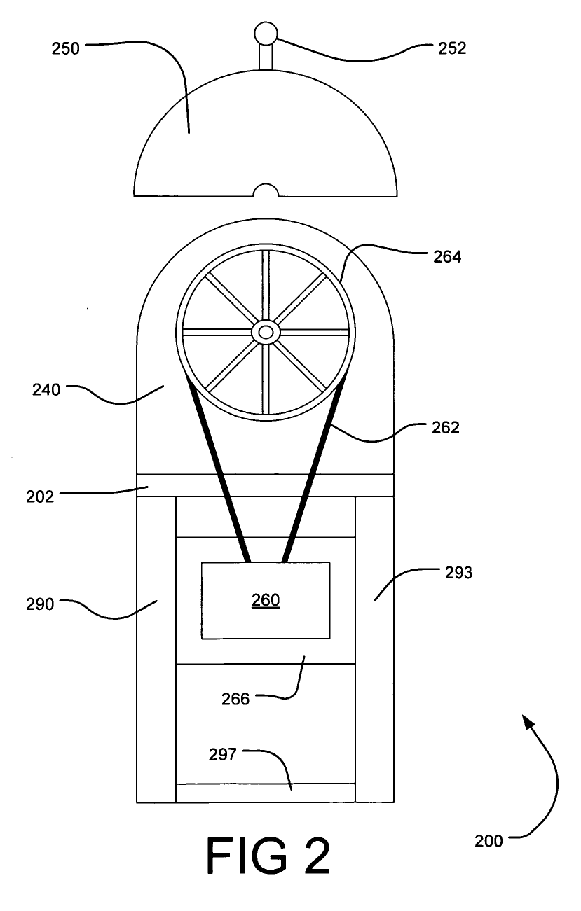

FIG. 2 illustrates a left side view of an exemplary embodiment of a bar-b-que cooking device 200. The cooking device's 200 left side wall 240 is shown above the primary heating device 202. Above the left side wall 240 is the optional lid 250. The lid 250 can be placed over the main body of the device 200 in order to better retain the heat and smoke within the device 200. The lid 250 can be maneuvered using the lid handle 252.

In the embodiment illustrated in FIG. 2, a main pulley 264 is shown in proximity to the left side wall 240. The main pulley 264 acts upon the basket 110 and causes the basket 110 to rotate when the pulley 264 rotates. The motor 260 acts upon the pulley 264 via the belt 262. As the motor 260 turns, it moves the belt 262, causing the pulley 264 to rotate. The motor 260 is supported by the motor support structure 266. The illustration in FIG. 2 also shows the left side support legs 290 and 293 and the cross-support 297.

It will readily be understood that the various motion components of this embodiment including the motor 260, belt 262, and pulley 264 could be implemented by other equivalent means. For example, a small propane engine could turn a worm gear acting upon a transmission which in turn acts directly on the basket 110 to cause rotational motion. Various modifications to the motion devices may be made without departing from the spirit of the invention and the scope of the appended claims.

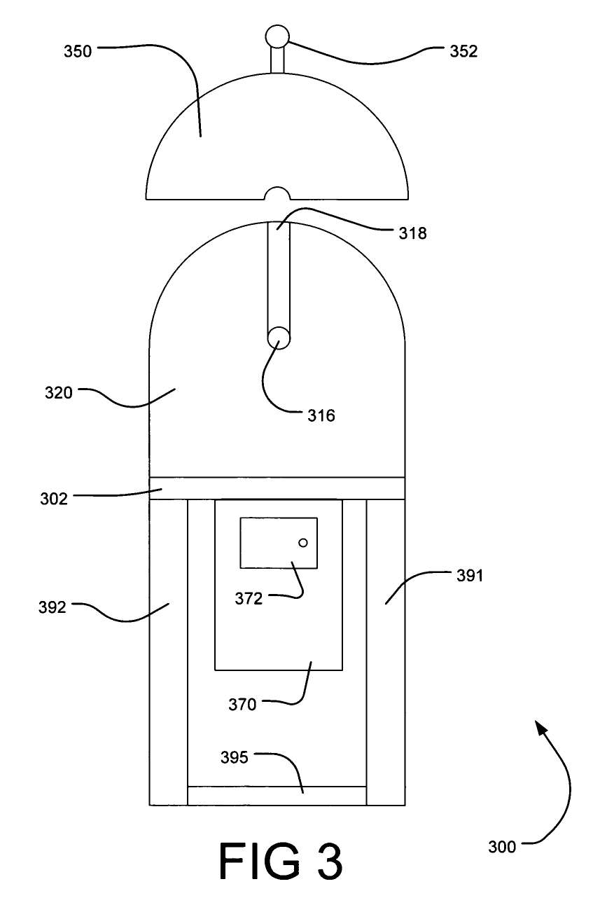

FIG. 3 illustrates a right side view of an exemplary embodiment of a bar-b-que cooking device 300. The cooking device's 300 right side wall 320 is shown above the primary heating device 302. Above the right side wall 320 is the optional lid 350. The lid 350 can be placed over the main body of the device 300 in order to better retain the heat and smoke within the device 300. The lid 350 can be maneuvered using the lid handle 352.

In the embodiment illustrated in FIG. 3, a smoke box 370 is shown. In alternate embodiments, alternative smoke producing or flavor enhancing components are contemplated. The smoke box 370 has an access door 372. A user opens the access door 372 and inserts wood chips or other smoke producing materials into the smoke box 370. The access door 372 is then closed and the controls 180 are used to activate the smoke box 370.

The basket retainer bolt handle 316 is placed in the access slot 318 in the right side wall 320. An unlocked basket 110 can be lifted out of the cooking device 300 by grasping the retainer bolt handle 316 and lifting.

It will readily be understood that the various flavor-enhancing components of this embodiment including the smoke box 370, the access door 372, and the controls 180 could be implemented by other equivalent means. For example, an automated smoker attachment could be placed in proximity to the primary heating device 302 such that heat from the primary device 302 produces smoke. The automated smoker could sense the amount of smoke output and automatically add wood chips to maintain a predetermined level. Various modifications to the flavor-enhancing devices may be made without departing from the spirit of the invention and the scope of the appended claims.

The descriptions above illustrate exemplary components that can make up an exemplary bar-b-que cooking device. The above specification, examples and data provide a description of the structure and use of exemplary embodiments of the invention. Since many embodiments of the invention can be made without departing from the spirit and scope of the invention, the invention resides in the claims, including those hereinafter appended. Other embodiments are therefore contemplated.

What is claimed is:

1. A bar-b-que cooking device, comprising:
a plurality of walls enclosing a cooking area;
a basket having a cooking chamber;
the basket placed within the cooking area;
a heating device operating in proximity to the basket; and
a motion device;
wherein the cooking chamber holds foodstuffs that are to be cooked by the heating device and the motion device acts upon the basket causing the foodstuffs to move.

2. The cooking device of claim 1 wherein the basket allows heat and smoke to enter the cooking chamber and act upon the foodstuffs.

3. The cooking device of claim 1, further comprising a smoke box.

4. The cooking device of claim 3 wherein the basket allows heat and smoke to enter the cooking chamber and act upon the foodstuffs.

5. The cooking device of claim 1 wherein the motion device acts upon the basket causing the basket to rotate.

6. The cooking device of claim 4 wherein the motion device acts upon the basket causing the basket to rotate.

7. The cooking device of claim 1, further comprising a serving drawer, wherein the serving drawer is positioned to receive cooked foodstuffs and wherein the serving drawer is removable.

8. The cooking device of claim 4, further comprising a serving drawer, wherein the serving drawer is positioned to receive cooked foodstuffs and wherein the serving drawer is removable.

9. The cooking device of claim 6, further comprising a serving drawer, wherein the serving drawer is positioned to receive cooked foodstuffs and wherein the serving drawer is removable.

10. The cooking device of claim 8 wherein the heating device is a plurality of electrical heating elements.

11. The cooking device of claim 9 wherein the heating device is a plurality of electrical heating elements.

12. The cooking device of claim 8 wherein the heating device is a plurality of gas burners.

13. The cooking device of claim 9 wherein the heating device is a plurality of gas burners.

14. A bar-b-que cooking device, comprising:
a plurality of walls enclosing a cooking area;
a basket having a cooking chamber;
the basket placed within the cooking area;
a heating device operating in proximity to the basket; and
an electric motor;
wherein the cooking chamber holds foodstuffs that are to be cooked by the heating device and the motor causes the basket to rotate.

15. The cooking device of claim 14, further comprising a smoke box.

16. The cooking device of claim 14, further comprising a serving drawer, wherein the serving drawer is positioned to receive cooked foodstuffs and wherein the serving drawer is removable.

17. The cooking device of claim 15, further comprising a serving drawer, wherein the serving drawer is positioned to receive cooked foodstuffs and wherein the serving drawer is removable.
